(19) United States
(12) Patent Application Publication
(10) Pub. No.: US 2013/0238372 A1
(43) Pub. Date: Sep. 12, 2013

(54) TRANSFERRING MOBILE TICKETS TO OTHERS

(71) Applicant: William Scott Jordan, Seattle, WA (US)

(72) Inventor: William Scott Jordan, Seattle, WA (US)

(73) Assignee: BROWN PAPER TICKETS LLC, Seattle, WA (US)

(21) Appl. No.: 13/584,596

(22) Filed: Aug. 13, 2012

Related U.S. Application Data
(60) Provisional application No. 61/609,559, filed on Mar. 12, 2012.

(51) Int. Cl. G06Q 10/02

(52) U.S. Cl. CPC G06Q 10/02
USPC 705/5

(57) ABSTRACT

Software transfers ownership of a mobile ticket from a ticket holder to a recipient. To conduct this transaction, the ticket holder provides a ticketing system with an e-mail address or mobile phone number of the recipient. The ticketing system then contacts the recipient via the e-mail address or mobile phone number and provides the recipient with a web link containing a unique transfer identifier for the transfer request. When the recipient follows the provided web link using a web browser, creates a new account or logs in to an existing account, the ticketing system moves the ticket from the ticket holder's account to the recipient's account.

### CROSS-REFERENCE TO RELATED APPLICATION

This application claims the benefit of Provisional Application No. 61/609559, filed Mar. 12, 2012, which is incorporated herein by reference.

### TECHNICAL FIELD

The present subject matter is generally related to software, and more particularly, it relates to transferring mobile tickets.

### BACKGROUND

A person has purchased a ticket to an event. But now he wants to give it to someone else without having to physically hand to the other person a ticket. Conventionally, this is difficult to accomplish. Here is an illustrative example. A group of friends decide to go to a movie. One person is chosen to purchase a number of tickets to the movie for himself and his friends. They are to meet at the theater. The person stands in a long line to get in to the theater hoping that his friends will show up in time to join him so that he can distribute the tickets. Unfortunately, his friends are late and the line has started to move. It would be desirable if the person were able to transfer the tickets to his friends without having to physically handing them the tickets.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the present subject matter includes a system form of the subject matter which recites a ticketing system which is configured to transfer a ticket. The ticketing system comprises an account server, being executed on a piece of hardware, which is configured to store a shopping cart of a ticket holder and a shopping cart of a recipient. The ticketing system further comprises a transferring component, being executed on the piece of hardware or another piece of hardware, which is configured to transfer a mobile ticket, without changing a name of a first owner of the mobile ticket, to a recipient from a ticket holder by associating the mobile ticket with the shopping cart of the recipient and disassociating the mobile ticket from the shopping cart of the ticket holder.

Another aspect of the present subject matter includes a method form of the subject matter which recites a method for transferring a ticket. The method comprises receiving a selection to transfer a mobile ticket to a recipient from a ticket holder. The method also comprises transferring the mobile ticket without requiring the recipient to bid for the ticket. The method further comprises removing other requests to transfer the mobile ticket by the ticket holder.

A further aspect of the present subject matter includes a computer-readable form of the subject matter reciting a computer-readable medium, which is non-transitory, having computer-executable instructions stored thereon to implement a method for transferring a ticket. The method comprises receiving a selection to transfer a mobile ticket to a recipient from a ticket holder. The method also comprises transferring the mobile ticket without requiring the recipient to bid for the ticket. The method further comprises removing other requests to transfer the mobile ticket by the ticket holder.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an archetypical ticketing system in accordance with various embodiments of the present subject matter;

FIG. 2 is a pictorial diagram illustrating elements of a user interface in accordance with various embodiments of the present subject matter;

FIG. 3 is a pictorial diagram illustrating elements of a user interface in accordance with various embodiments of the present subject matter;

FIG. 4A is a pictorial diagram illustrating elements of a user interface in accordance with various embodiments of the present subject matter;

FIG. 4B is a pictorial diagram illustrating elements of a user interface in accordance with various embodiments of the present subject matter;

FIG. 4C is a pictorial diagram illustrating elements of a user interface in accordance with various embodiments of the present subject matter; and

FIGS. 5A-5H are process diagrams illustrating an archetypical software method for transferring mobile tickets from a ticket holder (transferor) to a recipient (transferee) in accordance with various embodiments of the present subject matter.

### DETAILED DESCRIPTION

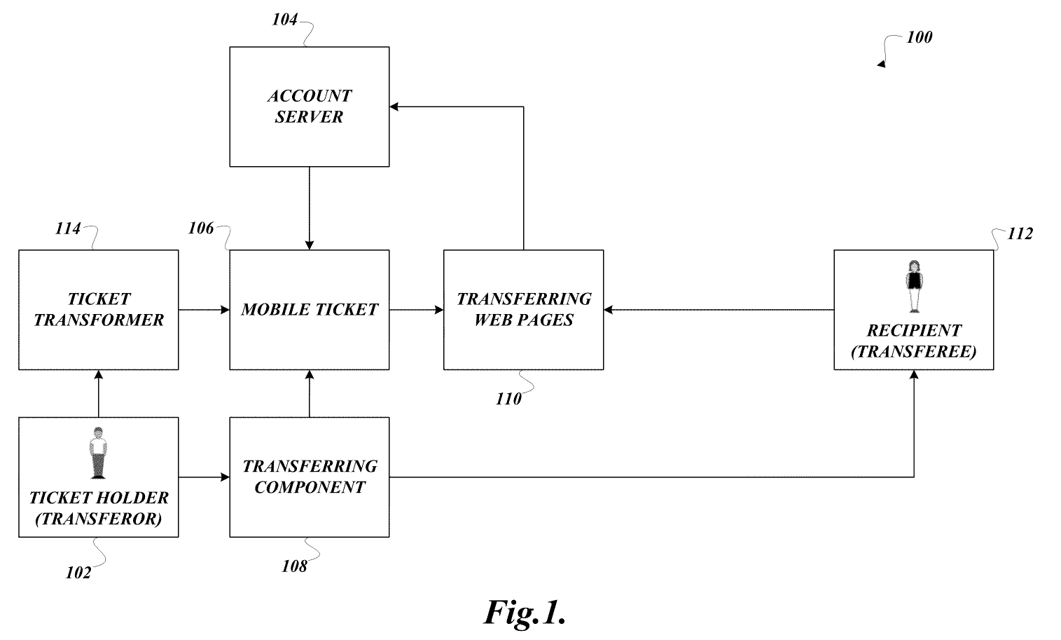

FIG. 1 illustrates a ticketing system 100 (implemented in hardware, software, or both) in which a ticket holder (transferor) 102 would like to transfer a ticket to a recipient (transferee) 112 without requiring the recipient to bid for the ticket. If the ticket held by the ticket holder 102 is in a form other than a mobile form of a ticket 106 (implemented in hardware, software, or both), the ticketing system 100 uses a ticket transformer 114 (implemented in hardware, software, or both) to transform the ticket (including will-call tickets, physical tickets, print-at-home tickets, and so on) into the mobile ticket 106 to facilitate transferring the ticket from the ticket holder 102 to the recipient 112. The ticket holder 102 uses a transferring component 108 (implemented in hardware, software, or both), which communicates with the recipient 112 to query whether the recipient 112 desires the ticket. If so, the transferring component 108 causes a presentation of transferring web pages 110 on a computing device, such as a mobile device, through which the recipient 112 interacts to facilitate the transfer of the mobile ticket 106. As would be appreciated by one with ordinary skill in this art, the present subject matter is not limited to the use of web pages but instead applies to any suitable interface mechanisms that may be used to present user interfaces to the recipient 112, such as mobile app's user interfaces, social media messages, and so on. An account server 104 (implemented in hardware, software, or both) maintains accounts or identifiers that allow the ticketing system 100 to track ownership of the mobile ticket 106 so as to facilitate transfer of the mobile ticket 106, such as the transfer of the ticket between the ticket holder 102 and the recipient 112. In some embodiments, there may not be a need to use accounts but instead any identifiers can be used to track ownership of the mobile ticket 106.

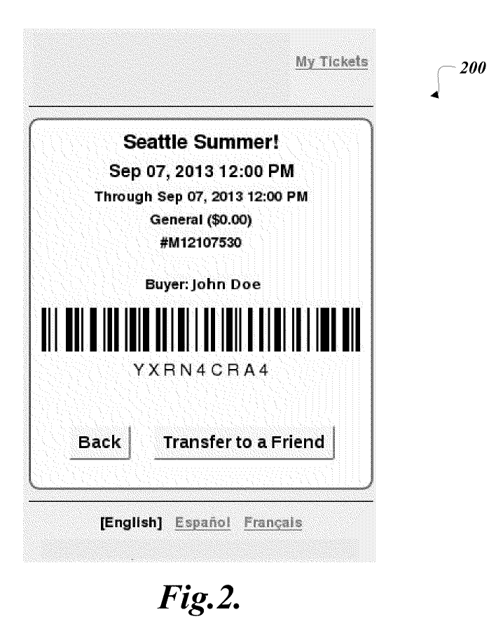

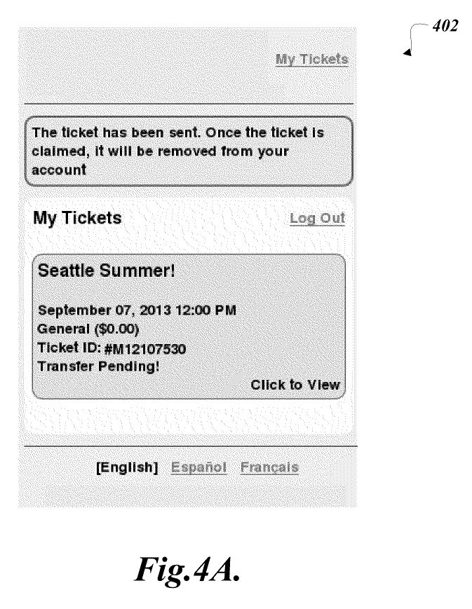

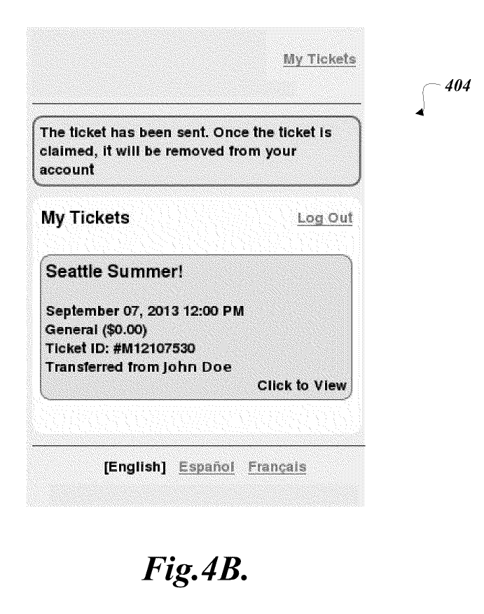

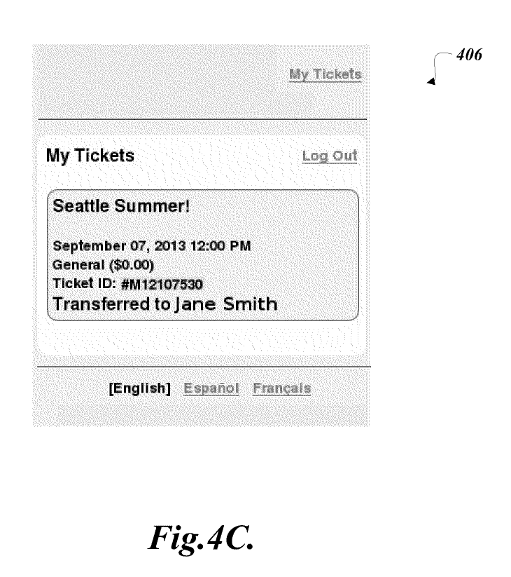

FIG. 2 illustrates a user interface 200 (implemented as part of an app or a web page) that represents a mobile ticket, such as the mobile ticket 106. The user interface 200 presents a number of user interface elements. At the top right of the user interface 200 is a hyperlink user interface element named “My Tickets” which is underlined to indicate that upon selection it would forward the ticket holder 102 to a user interface page, such as a user interface 402 (FIG. 4A), which presents one or more mobile tickets owned by the ticket holder 102 or being transferred from the ticket holder 102 to the recipient 112.

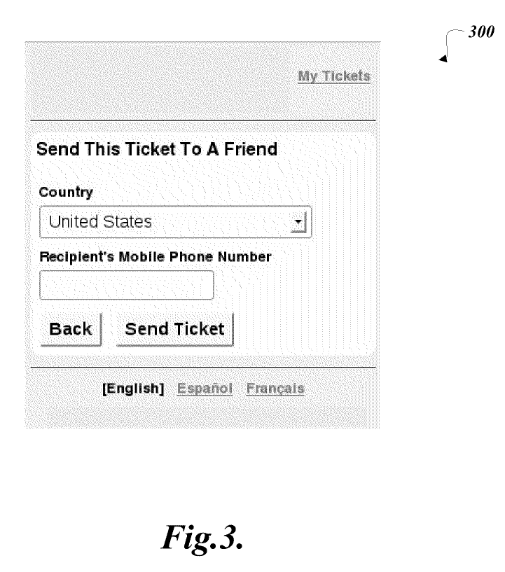

Returning to FIG. 2, below the hyperlink user interface element named “My Tickets,” the user interface 200 presents a title user interface element that is indicative of the name of the event, which recites “Seattle Summer!” Below the title user interface element is a date-of-the-event user interface element, which recites “Sep. 7, 2013” and a time-of-the-event user interface element, which recites “12:00 PM.” Below the date and time user interface elements is a validity-period user interface element which recites “through Sep. 7, 2013 12:00 PM,” indicating the date and time through which the mobile ticket is valid. Below the validity-period user interface element is an admission user interface element which recites “General ($0.00).” Below the admission user interface element is a ticket identifier user interface element which recites “#M12107530,” indicating a unique ticket identifier of the mobile ticket. In all embodiments of the present subject matter, the unique ticket identifier remains unique throughout the life of the ticket without changing to facilitate fraud prevention by the ticketing system 100. Below the ticket identifier user interface element is a buyer user interface element, which recites “Buyer: John Doe.” In all embodiments of the present subject matter, the identity of the buyer of the ticket does not change even if the ticket has been transferred one or more times so as to allow the ticketing system 100 to provide fraud prevention services. For example, the ticketing system 100 prevents a situation where someone purchases a ticket in his name, is admitted to an event that is not using bar codes (e.g., names on a list and so on), transfers the ticket to someone else with a new name, causes that person's new name to show up on a list, and then allows that person to show up to the event for free. Subjacent to the buyer user interface element is a graphical representation of a bar code and subjacent to that is an ASCII representation of the bar code, which recites “YXRN4CRA4.” Note that this bar code also uniquely identifies a ticket, which is a redundant treatment in addition to the unique ticket identifier so as to facilitate fraud prevention. Additionally, in a few embodiments, the bar code is used at the event to gain entry whereas the ticket identifier is used by the ticketing system to identify the ticket to the event. Below the ASCII representation of the bar code is a button named “Back” which when actuated, returns the ticket holder 102 to a previous web page that precedes the user interface 200. Another button is positioned adjacent to the “Back” button named “Transfer to a Friend.” Selecting the “Transfer to a Friend” button navigates the ticket holder 102 to one or more web pages to allow him to transfer his mobile ticket 106 to another, such as a user interface 300 (FIG. 3). Below the buttons mentioned above are hyperlinks that localize the language of the user interface 200, which include English, Español, and Français. Selection of one of these three hyperlinks translates the user interface 200 to the selected language. FIG. 3 illustrates the user interface 300 (implemented as part of an app or a web page), which is presented to the ticket holder when he selects the “Transfer to a Friend” button of the user interface 200 (FIG. 2). A hyperlink named “My Tickets” is located in the upper right-hand corner of the user interface 300. Upon selection, the hyperlink “My Tickets” brings the ticket holder 102 to the user interface 402 (FIG. 4A). Below the hyperlink “My Tickets” are a number of user interface elements all of which are directed to assist the ticket holder 102 to transfer his mobile ticket. The first interface element that is located just below the “My Tickets” hyperlink is a title user interface named “Send This Ticket To A Friend.” Subjacent to this is a pulldown menu named “Country,” which upon selection of the downward pointing arrowhead allows the ticket holder 102 to specify the country in which the recipient 104's mobile phone is registered. Below the pulldown menu “Country” is a phone user interface element named “Recipient's Mobile Phone Number” into which the ticket holder 102 may enter the mobile phone number of the recipient 112. In other embodiments, instead of entering a mobile phone number of the recipient 112, the ticket holder 102 may use the e-mail address of the recipient 112, or any other suitable electronic contact information that would communicate with the recipient 112. Subjacent to the phone user interface element are two buttons. The first button is named “Back,” and upon selection, it brings the ticket holder 102 back to a previous user interface, such as the user interface 200 (FIG. 2). The second button is named “Send Ticket,” and upon selection, the ticketing system 100 sends an invitation to the recipient 112 for her to consider whether or not to activate the transferring process. Below these two buttons are localization features displayed as hyperlinks for which there are three options, English, Español, and Français. Selection of one of these hyperlinks would cause a translation of the user interface 300 into the language of choice.

A user interface 402 (implemented as part of an app or a web page) is shown on FIG. 4A which is presented when the ticket holder 102 selects the hyperlink named “My Tickets.” The user interface 402 shows a shopping cart's contents of an account. If the ticket holder 102 has selected the “Send Ticket” button of the user interface 300 (FIG. 3), a status user interface element recites “The ticket has been sent. Once the ticket is claimed, it will be removed from your account.” This status user interface element is located below a “My Tickets” hyperlink of the user interface 402. As indicated previously, selection of this hyperlink causes the presentation of the user interface 402. Below the status user interface element, a title user interface element named “My Tickets” is presented to the left of the user interface 402. And to the right, along the same longitudinal line is a hyperlink named “Log Out.” Upon selection, the “Log Out” hyperlink exits the ticket holder 102 from the ticketing system 100. Below the title user interface element are a collection of user interface elements regarding the mobile ticket. For example, the name of the event “Seattle Summer!” is presented below the title user interface element. Below that, the date “Sep. 7, 2013” and the time “12:00 PM” are presented. Subjacent to that is the admission information “General ($0.00).” Below that is the unique ticket identifier “Ticket ID: #M12107530.” And below that, the status of the ticket is recited as “Transfer Pending!”. At the lower right-hand corner is a hyperlink named “Click to View,” and upon selection, it brings the ticket holder 102 to a presentation of the mobile ticket, much like the user interface 200 (FIG. 2), which provides the ticketing information in greater detail. At the bottom of the user interface 402 are localization features which include English, Español, and Français, all of which are hyperlinks and can be selected to translate to the language being presented.

The recipient 112 may obtain a status from the ticketing system 100 via a user interface 404 (implemented as part of an app or a web page). See FIG. 4B. The user interface 404 is similar to the user interface 402 (FIG. 4A) except it is collated for the recipient 112, which lists one or more mobile tickets owned by the recipient 112 or being transferred to the recipient 112. The user interface 404 includes a hyperlink named “My Tickets,” which upon selection forwards the recipient 112 to a user interface like the user interface 200 (see FIG. 2). Below the “My Tickets” hyperlink is a status user interface element that recites “The ticket has been sent. Once the ticket is claimed, it will be removed from your account.” In other embodiments, such a status user interface is not shown to the recipient 112. Below the status user interface element is a title user interface element named “My Tickets”. To its right is a hyperlink named “Log Out” which upon selection causes the ticketing system 100 to log the recipient 112 out from the ticketing system 100. Below the title user interface element is information pertaining to the transferred mobile ticket 106. The event of the transferred mobile ticket 106 is named “Seattle Summery!” Below that is the event date “Sep. 7, 2013” and the time of the event “12:00 PM.” Subjacent to that is the admission type of the transferred mobile ticket 106 reciting “General ($0.00).” And below that is a unique ticket identifier “Ticket ID: #M12107530.” Subjacent to that is the status of the mobile ticket 106 which recites “Transferred from John Doe.” Subjacent to that is a hyperlink named “Click to View” which upon selection brings the recipient 112 to a user interface much like the user interface 200 (FIG. 2). At the bottom of the user interface 404 are localization features, English, Español, and Français, each of which upon selection translates the user interface 404 into the language selected.

A user interface 406 (implemented as part of an app or a web page) is presented to the ticket holder 102 that explains the status of the transferred mobile ticket 106. See FIG. 4C. At the top of the user interface 406 is a hyperlink named “My Tickets” which upon selection forwards the ticket holder 102 to a page much like the user interface 406. Below the “My Tickets” hyperlink is a title user interface named “My Tickets” and to its right is a hyperlink named “Log Out” which upon selection, causes the ticketing system 100 to cause the ticket holder 102 to exit from the ticketing system 100. Below the title user interface element is a ticket user interface element which details the transferred mobile ticket 106. The name of the event is recited as “Seattle Summer!” Below that is the date of the event “Sep. 7, 2013” and the time of the event “12:00 PM.” Subjacent to that is the admission type of the ticket which is recited as “General ($0.00).” Subjacent to that is the unique ticket identifier “Ticket ID: #M12107530.” And below that is the status of the transfer process which in this case recites “Transferred to Jane Smith.” At the bottom of the user interface 406 are localization options (English, Español, and Français) all of which upon selection translates the user interface 406 into the language of choice.

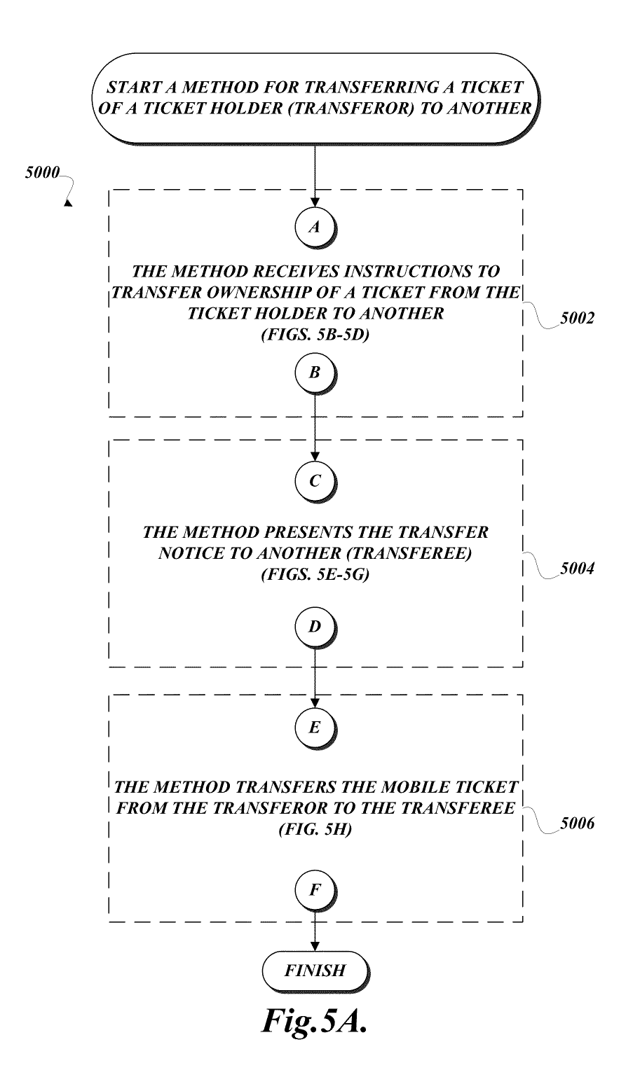

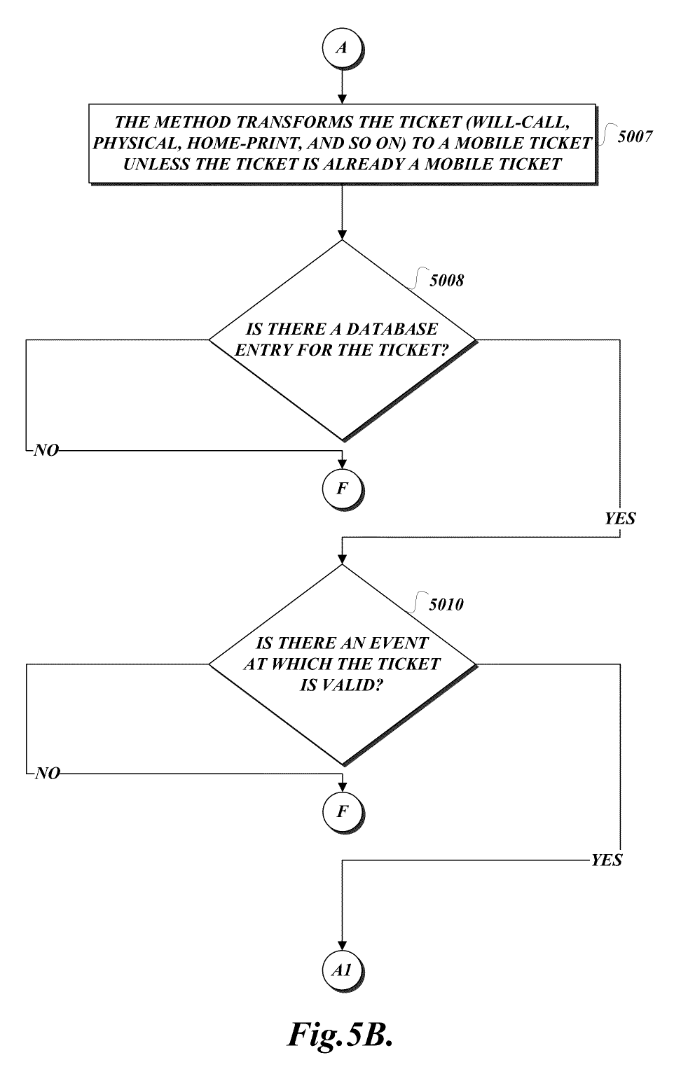

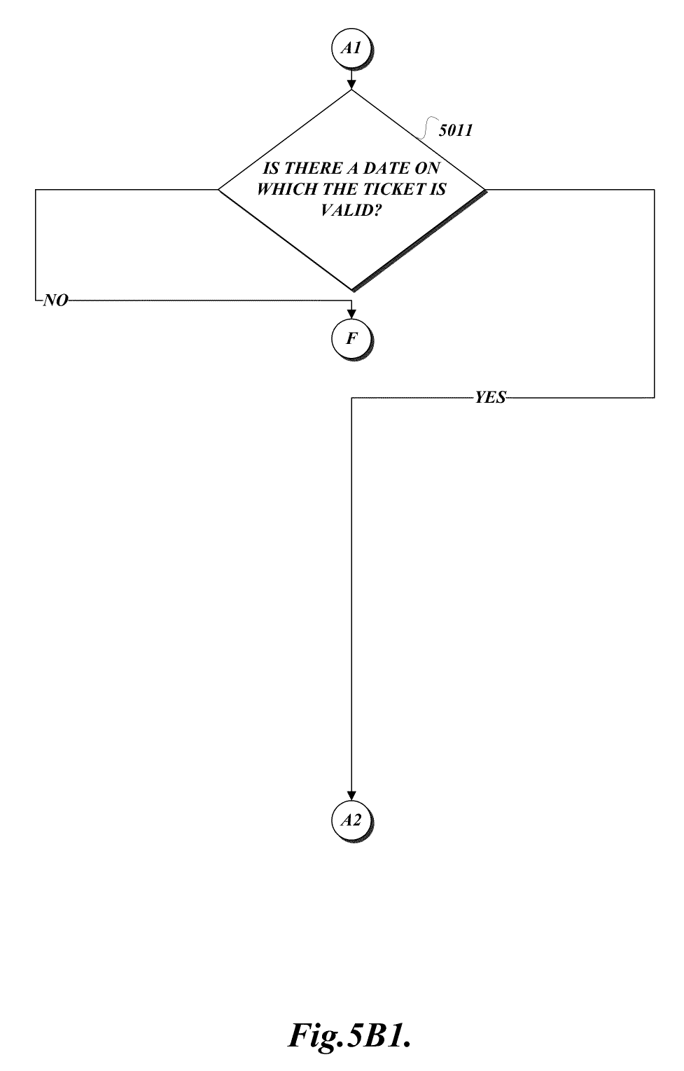

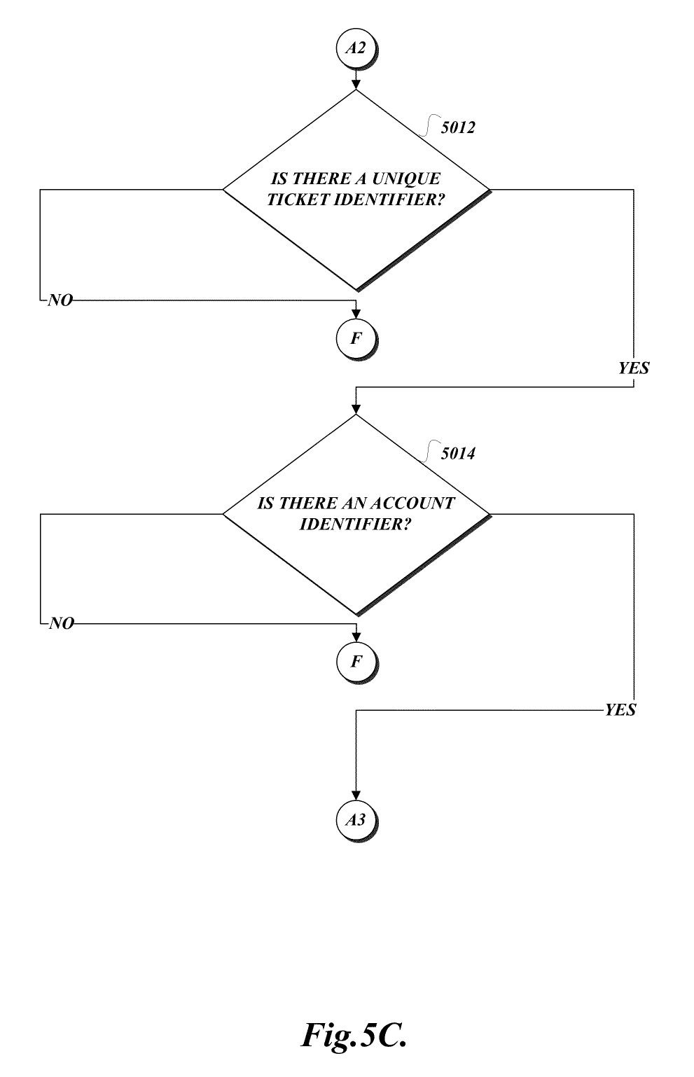

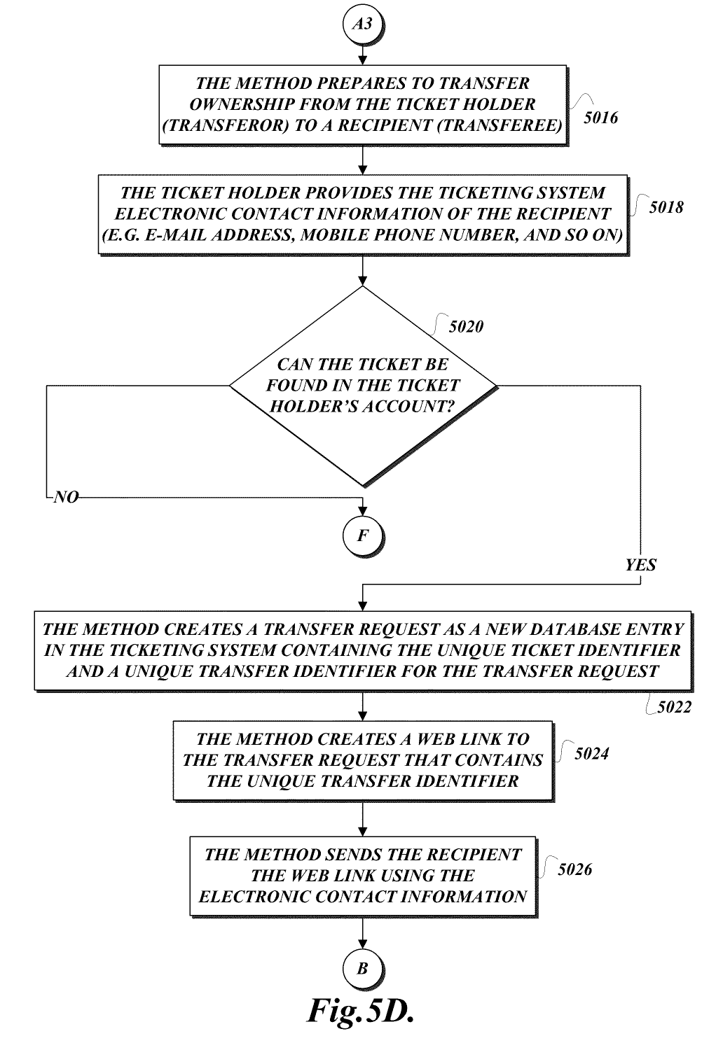

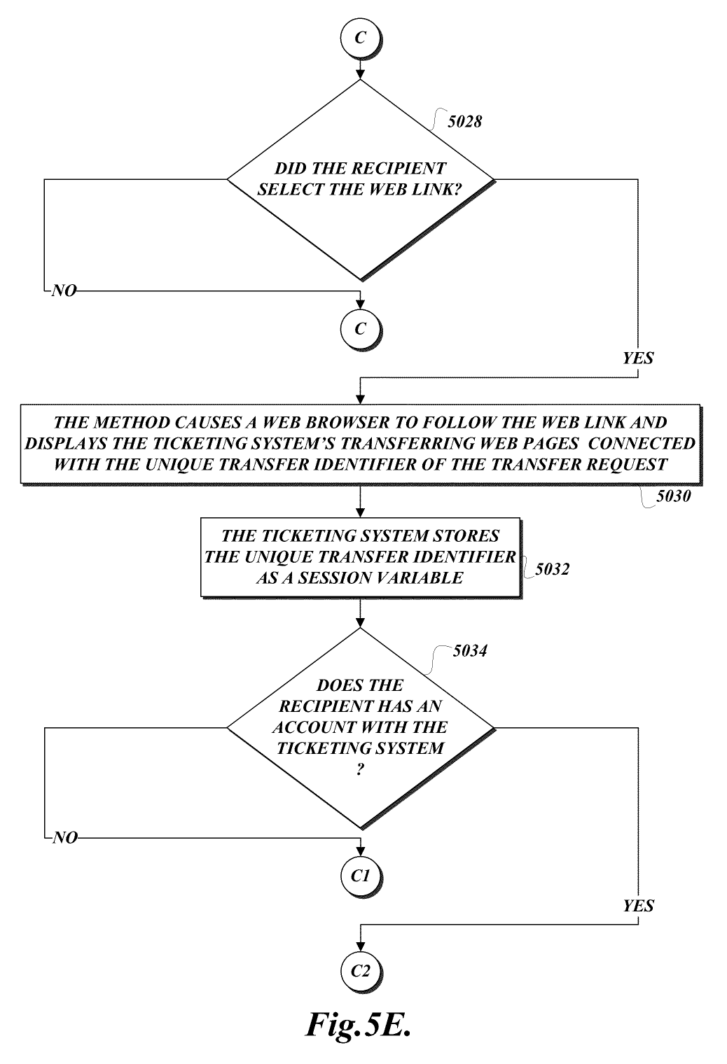

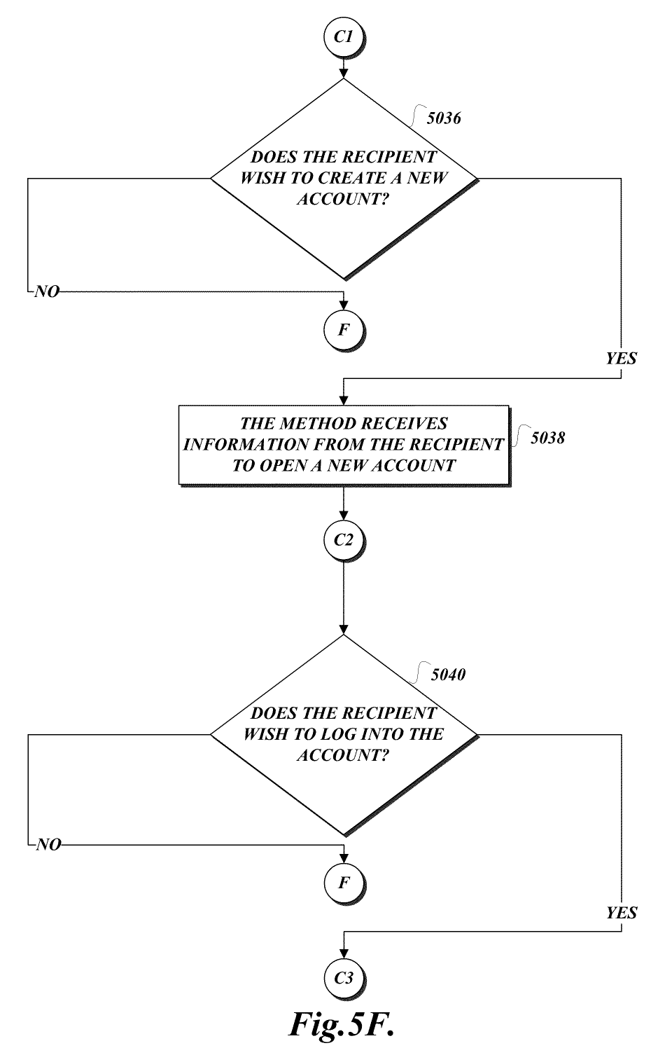

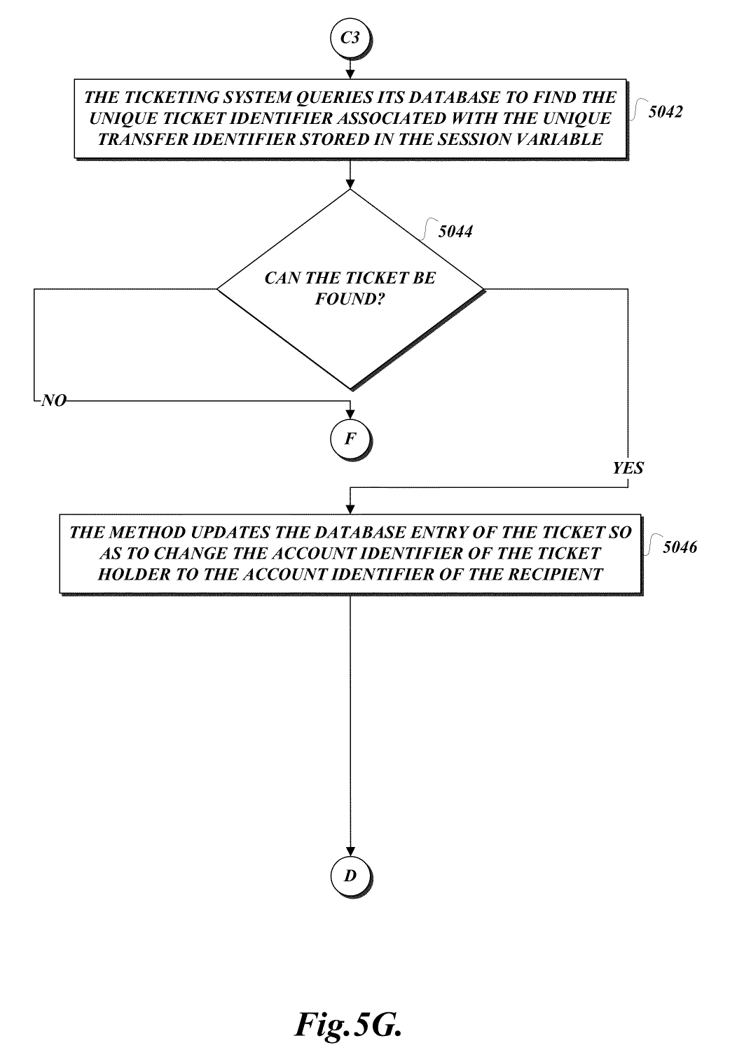

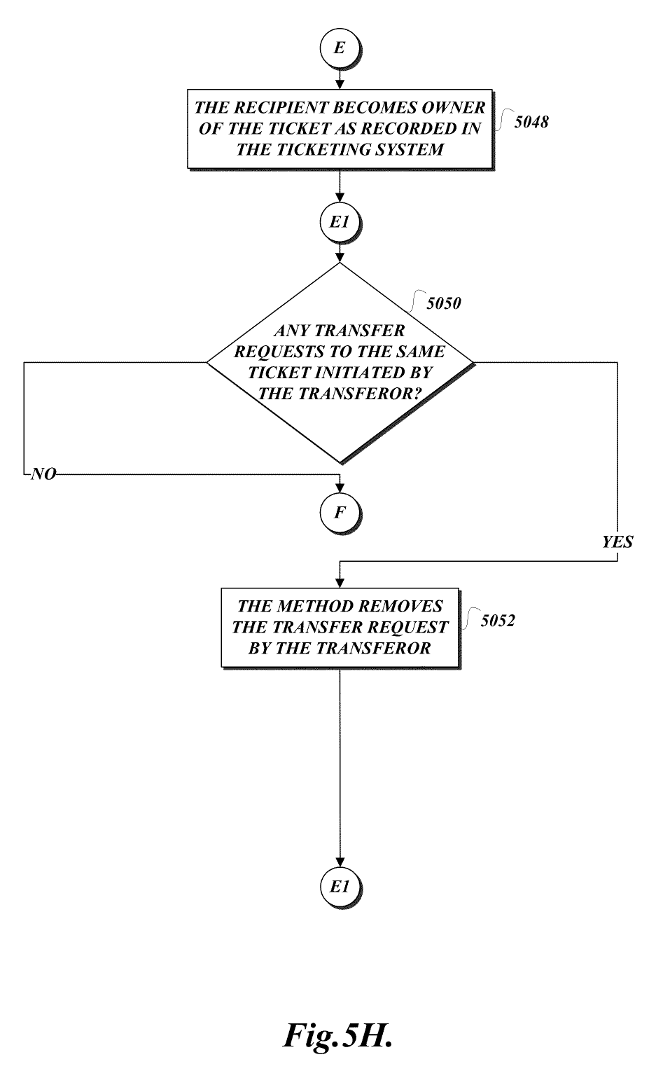

FIGS. 5A-5H present a method 5000 for transferring a ticket of the ticket holder (transferor) 102 to another, such as the recipient (transferee) 112. From a start block, the method 5000 proceeds to a set of method steps 5002 defined between a continuation terminal (“terminal A”) and another continuation terminal (“terminal B”). The set of method steps 5002 receives instructions to transfer ownership of a ticket from the ticket holder to another. See FIGS. 5B-5D. From terminal A (FIG. 5B), the method 5000 proceeds to block 5007 where the method transforms the ticket (will-call, physical, home-print, and so on) to a mobile ticket, such as the mobile ticket 106, unless the ticket is already a mobile ticket. At decision block 5008, a test is performed to determine whether there is a database entry for the ticket 106. If the answer is NO to the test at decision block 5008, the method proceeds to another continuation terminal (“terminal F”) and terminates execution (FIG. 5A).

Otherwise, if the answer to the test at decision block 5008 is YES, the method proceeds to another decision block 5010 where a test is performed to determine whether there is an event at which the ticket is valid. If the answer to the test at decision block 5010 is NO, the method proceeds to terminal F and terminates execution (FIG. 5A). Otherwise, if the answer to the test at decision block 5010 is YES, the method proceeds to another continuation terminal (“terminal A1”). From terminal A1 (FIG. 5B1), the method proceeds to decision block 5011 where a test is performed to determine whether there is a date on which the ticket is valid. If the answer to the test at decision block 5011 is NO, the method proceeds to terminal F and terminates execution (FIG. 5A). Otherwise, if the answer to the test at decision block 5011 is YES, the method proceeds to another continuation terminal (“terminal A2”). In a few embodiments, the ticketing system 100 keeps separate the event information from the date information. In a number of embodiments, the ticketing system 100 needs not keep separate the event information from the date information. This allows the ticketing system 100 to model a situation where an event may occur multiple times at the same venue. Thus, a ticket to an event at a time different from another time to the same event may constitute a different ticket.

From terminal A2 (FIG. 5C), the method proceeds to decision block 5012 where a test is performed to determine whether there is a unique ticket identifier. If the answer to the test at decision block 5012 is NO, the method proceeds to terminal F and terminates execution (FIG. 5A). Otherwise, if the answer to the test at decision block 5012 is YES, the method proceeds to another decision block 5014 where a test is performed to determine whether there is an account identifier. In other embodiments, the account identifier need not be used and instead other suitable identifiers, such as one's e-mail or one's mobile phone number, among many other suitable identifiers, can be used. If the answer to the test at decision block 5014 is NO, the method proceeds to terminal F and terminates execution (FIG. 5A). Otherwise, if the answer to the test at decision block 5014 is YES, the method proceeds to another continuation terminal (“terminal A3”).

From terminal A3 (FIG. 5D), the method 5000 proceeds to block 5016 where the method prepares to transfer ownership from the ticket holder (transferor) 102 to the recipient (transferee) 112. Proceeding next to block 5018, the ticket holder provides the ticketing system 100 with the electronic contact information of the recipient (e.g., e-mail address, mobile phone number, and so on). The method then continues to decision block 5020 where a test is performed to determine whether the ticket can be found in the ticket holder's account. If the answer to the test at decision block 5020 is NO, the method proceeds to terminal F and terminates execution (FIG. 5A). Otherwise, if the answer to the test at decision block 5020 is YES, the method proceeds to block 5022 where the method creates a transfer request as a new database entry in the ticketing system containing the unique ticket identifier and a unique transfer identifier for the transfer request. Moving on to block 5024, the method creates a Web link to the transfer request that contains the unique transfer identifier. At block 5026, the method 5000 sends the recipient the Web link using the electronic contact information. The method then continues to terminal B.

From terminal B (FIG. 5A), the method 5000 proceeds to a set of method steps 5004 where the method presents the transfer notice to another (transferee), such as the recipient 112. See FIGS. 5E-5G. The set of method steps 5004 is defined between a continuation terminal (“terminal C”) and another continuation terminal (“terminal D”). From terminal C (FIG. 5E), the method proceeds to decision block 5028 where a test is performed to determine whether the recipient selects a Web link. In other words, the ticketing system 100 decides whether the recipient 112 has selected the Web link that is provided via the electronic contact information, such as e-mail or a text message via SMS or other suitable communication means. If the answer to the test at decision block 5028 is NO, the method continues to terminal C and skips back to decision block 5028 where the above-identified processing steps are repeated. Otherwise, if the answer to the test at decision block 5028 is YES, the method 5000 proceeds to block 5030 where the method causes a Web browser to follow the Web link and displays the ticketing system's transferring Web pages 110 connected with the unique transfer identifier of the transfer request. In some embodiments, the ticketing system 100 also extracts the unique ticket identifier from the database record associated with the unique transfer identifier. At block 5032, the ticketing system 100 stores the unique transfer identifier as a session variable. The method then continues to decision block 5034 where a test is performed to determine whether the recipient has an account with the ticketing system 100. If the answer to the test at decision block 5034 is NO, the method proceeds to another continuation terminal (“terminal C1”). Otherwise, if the answer to the test at decision block 5034 is YES, the method proceeds to another continuation terminal (“terminal C2”).

From terminal C1 (FIG. 5F), the method 5000 proceeds to decision block 5036 where a test is performed to determine whether the recipient wishes to create a new account. If the answer to the test at decision block 5036 is NO, the method proceeds to terminal F and terminates execution (FIG. 5A). Otherwise, if the answer to the test at decision block 5036 is YES, the method at block 5038 receives information from the recipient 112 to open a new account via the account server 104. The received pieces of information include the e-mail address of the recipient 112, password, and a zipcode, among other suitable pieces of information, to open the new account. The method then continues to terminal C2 (FIG. 5F). The method further proceeds to decision block 5040 where a test is performed to determine whether the recipient 112 wishes to log into the account. If the answer to the test at decision block 5040 is NO, the method proceeds to terminal F and terminates execution (FIG. 5A). Otherwise, if the answer to the test at decision block 5040 is YES, the method proceeds to another continuation terminal (“terminal C3”).

From terminal C3 (FIG. 5G), the method proceeds to block 5042 where the ticketing system 100 queries its database to find a unique ticket identifier associated with the unique transfer identifier stored in the session variable. The method then proceeds to decision block 5044 where a test is performed to determine whether the ticket can be found. If the answer to the test at decision block 5044 is NO, the method proceeds to terminal F and terminates execution (FIG. 5A). Otherwise, if the answer to the test at decision block 5044 is YES, the method proceeds to decision block 5046 where the method updates the database entry of the ticket, changing the account identifier of the ticket holder 102 to the account identifier of the recipient 112. The method then continues to terminal D.

Digressing, the ticketing system 100 creates an account for each user, such as the ticket holder 102 and the recipient 112. These accounts are stored in an account table, each of which is associated with an account identifier. Each account has an electronic shopping cart into which is stored all purchased tickets and all transferred tickets. The electronic shopping cart has a shopping cart table. Each electronic shopping cart is associated with a shopping cart identifier and an account identifier. Separately, the ticketing system also stores mobile tickets in a ticket table. Each mobile ticket is associated with a unique ticket identifier and a shopping cart identifier. After a mobile ticket has been transferred, it is associated with the shopping cart of the recipient and is disassociated with the shopping cart of the ticket holder. A separate ticket history table reveals the chain of ownership of each ticket. For example, an illustrative history may reveal that a ticket was purchased as a will-call ticket, was transformed to a mobile ticket, and subsequently was transferred to another.

Returning, from terminal D, the method 5000 proceeds to a set of method steps 5006, defined between a continuation terminal (“terminal E”) and terminal F. The set of method steps 5006 transfers the mobile ticket 106 from the transferor 102 to the transferee 112. From terminal E (FIG. 5H), the method 5000 proceeds to block 5048 where the recipient becomes the owner of the ticket as recorded in the ticketing system 100. In some embodiments, the transferred mobile ticket is associated with the shopping cart identifier of the account of the recipient 112 instead of the shopping cart identifier of the account of the ticket holder 102 to indicate the transfer of ownership of the ticket. The method then continues to another continuation terminal (“terminal E1”). From terminal El the method further proceeds to decision block 5050 where a test is performed to determine whether any transfer requests to the same ticket were initiated by the ticket holder 102. If the answer to the test at decision block 5050 is NO, the method proceeds to terminal F and terminates execution (FIG. 5A). Otherwise, if the answer to the test at decision block 5050 is YES, the method proceeds to block 5052 where the method removes the transfer request by the transferor. In some embodiments, the ticket holder 102 may have issued multiple transfer requests, so the ticketing system 100 executes one transfer request and marks any imperfect transfer requests from the system as obsolete without removing them from the system. The method then continues to terminal E1 and skips back to decision block 5050 where the above-identified processing steps are repeated.

While illustrative embodiments have been illustrated and described, it will be appreciated that various changes can be made therein without departing from the spirit and scope of the invention.

The embodiments of the invention in which an exclusive property or privilege is claimed are defined as follows:

1. A ticketing system configured to transfer a ticket, comprising:
an account server, being executed on a piece of hardware, which is configured to store a shopping cart of a ticket holder and a shopping cart of a recipient; and
a transferring component, being executed on the piece of hardware or another piece of hardware, which is configured to transfer a mobile ticket, without changing a name of a first owner of the mobile ticket, to a recipient from a ticket holder by associating the mobile ticket with the shopping cart of the recipient and disassociating the mobile ticket from the shopping cart of the ticket holder.

2. The ticketing system of claim 1, further comprising a ticket transformer, being executed on the piece of hardware or another piece of hardware, which is configured to transform the ticket to the mobile ticket, the ticket being selected from a group consisting essentially of a will-call ticket, a physical ticket, and a print-at-home ticket.

3. A method for transferring a ticket, comprising:
receiving a selection to transfer a mobile ticket to a recipient from a ticket holder;
transferring the mobile ticket without requiring the recipient to bid for the ticket; and
removing other requests to transfer the mobile ticket by the ticket holder.

4. The method of claim 3, further comprising transforming the ticket to the mobile ticket, the ticket being selected from a group consisting essentially of a will-call ticket, a physical ticket, and a print-at-home ticket.

5. The method of claim 3, wherein prior to receiving the selection to transfer, sending the recipient a web link to a transfer request that contains a unique transfer request identifier.

6. The method of claim 3, wherein transferring includes updating ownership of the mobile ticket by associating the mobile ticket with a shopping cart of the recipient and disassociating the mobile ticket from a shopping cart of the ticket holder.

7. The method of claim 6, wherein updating updates ownership of the mobile ticket without changing a name of an original owner of the mobile ticket.

8. The method of claim 3, wherein the act of transferring is executed if there exists an event at which the mobile ticket is valid.

9. The method of claim 3, wherein the act of transferring is executed if there exists a date and time on which the mobile ticket is valid.

10. The method of claim 3, wherein the act of transferring is executed if there exists an event at which the mobile ticket is valid and if there exists a date and time on which the mobile ticket is valid.

11. The method of claim 3, wherein the act of removing marks other requests to transfer the mobile ticket by the ticket holder as obsolete without removing the other requests from a ticketing system.

12. A computer-readable medium, which is non-transitory, having computer-executable instructions stored thereon to implement a method for transferring a ticket, comprising:
receiving a selection to transfer a mobile ticket to a recipient from a ticket holder;
transferring the mobile ticket without requiring the recipient to bid for the ticket; and
removing other requests to transfer the mobile ticket by the ticket holder.

13. The computer-readable medium of claim 12, further comprising transforming the ticket to the mobile ticket, the ticket being selected from a group consisting essentially of a will-call ticket, a physical ticket, and a print-at-home ticket.

14. The computer-readable medium of claim 12, wherein prior to receiving the selection to transfer, sending the recipient a web link to a transfer request that contains a unique transfer request identifier.

15. The computer-readable medium of claim 12, wherein transferring includes updating ownership of the mobile ticket by associating the mobile ticket with a shopping cart of the recipient and disassociating the mobile ticket from a shopping cart of the ticket holder.

16. The computer-readable medium of claim 15, wherein updating updates ownership of the mobile ticket without changing a name of an original owner of the mobile ticket.

17. The computer-readable medium of claim 12, wherein the act of transferring is executed if there exists an event at which the mobile ticket is valid.

18. The computer-readable medium of claim 12, wherein the act of transferring is executed if there exists a date and time on which the mobile ticket is valid.

19. The computer-readable medium of claim 12, wherein the act of transferring is executed if there exists an event at which the mobile ticket is valid and if there exists a date and time on which the mobile ticket is valid.

20. The computer-readable medium of claim 12, wherein the act of removing marks other requests to transfer the mobile ticket by the ticket holder as obsolete without removing the other requests from a ticketing system.
